(19) United States
(12) Patent Application Publication
(10) Pub. No.: US 2023/0158615 A1
(43) Pub. Date: May 25, 2023

(54) LASER ENGRAVER MACHINE CARRIAGE WITH VERTICAL ADJUSTABILITY

(71) Applicant: Tong Li, Haslett, MI (US)

(72) Inventor: Tong Li, Haslett, MI (US)

(21) Appl. No.: 17/984,277

(22) Filed: Nov. 10, 2022

Related U.S. Application Data
(60) Provisional application No. 63/282,401, filed on Nov. 23, 2021.

(51) Int. Cl. B23K 37/02

(52) U.S. Cl. CPC B23K 37/02; B23K 26/362

(57) ABSTRACT

A frame like structure supporting a laser engraving machine between left and right vertically adjustable pedestal. Each pedestal is mounted to a set of vertically oriented screw shafts wherein at least one shaft on each side frame is driven by a stepper motor connected to the screw shaft adjacent the bottom end thereof. Manually operated locks are provided at the tops of the screw shaft to prevent inadvertent rotation caused by the weight of the engraving machine in the event of a motor failure. The pairs of screw shafts on each side of the frame are coupled by belts to permit one motor to rotate both shafts and one lock to lock both shafts.

### CROSS-REFERENCE TO RELATED APPLICATIONS

This application claims in part the benefit of U.S. Provisional Application Ser. No. 63/282,401, filed on Nov. 23, 2021, the entire contents of which are incorporated herein by reference.

### TECHNICAL FIELD

A carriage of framework construction is designed to support laser machine cabinet and provide motor powered vertical movement of the cabinet to adjust its elevation relative to a workpiece.

### BRIEF SUMMARY OF THE DISCLOSURE

A height-adjustable carriage for a laser engraving machine cabinet is disclosed in my U.S. Pat. No. 8,309,881 issued in November of 2012. The carriage comprises a frame structure with vertically movable engraver cabinet supports mounted on screw shafts driven by stepper motors located at the tops of the shafts. In accordance with the first aspect of the present invention, manual locks are placed on one of the screws shafts on each side of the carriage. The locks can be operated to prevent the weight of the engraver machine from causing the screw shafts to free run as a result of motor failure in the lowering direction and potentially causing damage to the machine and/or a device being engraved such a grave marker.

In accordance with a second aspect of the invention, the motors that rotate the screw shafts are located adjacent to the bottoms of the screw shafts where they are less likely to be inadvertently contacted by an operator. This is particularly important after the motors have run long enough to raise the temperature of the motor housings.

### BRIEF DESCRIPTION OF THE DRAWINGS

The carriage will be described with reference to a series of drawings showing the carriage in various stages of assembly. The drawings are briefly described as follows:

FIG. 1 is a perspective view of the overall carriage construction with no laser engraving machine mounted within it and with the laser machine carriage mechanism in a lowered position;

FIG. 2 is another perspective view of the carriage of FIG. 1 with the mechanism for engaging and holding the engraving machine in a raised position;

FIG. 3 is another perspective view of the carriage from a different angle;

FIG. 4 is another perspective view of the carriage from the same angle as FIG. 3 but with a panel located to the upper rear portion removed to illustrate the location of electronic components including a power supply and a motor drive;

FIG. 5 is a perspective drawing of the completed carriage with a laser machine mounted within in it and placed in a fully lowered position;

FIG. 6 is another perspective view of the carriage loaded with a laser machine and with the machine in a fully raised position;

FIG. 6A is identical to FIG. 6 but shows a workpiece placed within the confines of the carriage and directly beneath the laser engraving machine;

FIG. 7 is an exploded view of the carriage without connecting hardware for the various beam like components thereof;

FIG. 8 is another exploded view of the carriage with representative showings of typical connecting hardware for the various beams;

FIG. 9 is a drawing of an exemplary shaft lock; and

FIG. 10 is a drawing of a carriage with the motors 30 relocated to a position at or near the bottom of the side frames.

### DETAILED DESCRIPTION THE PREFERRED EMBODIMENT

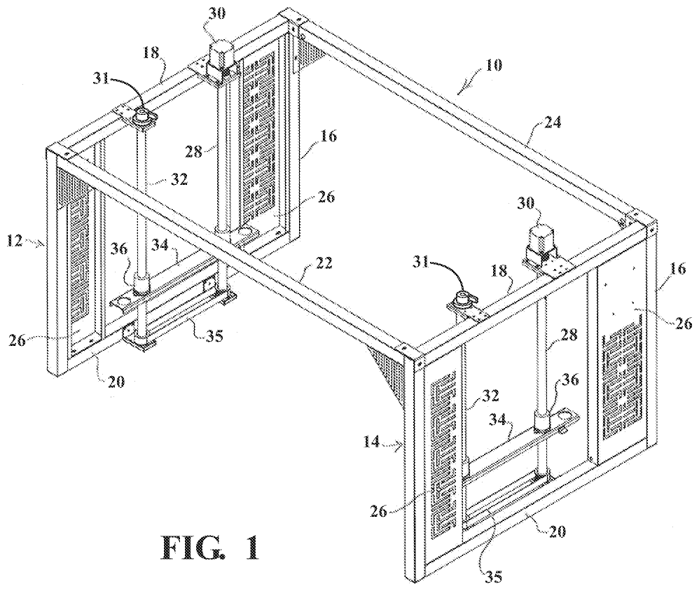

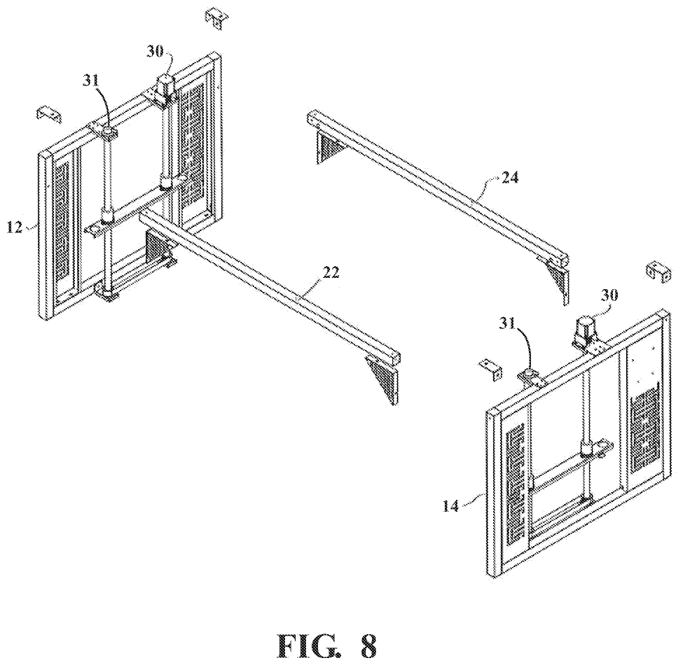

Referring now to the figures, FIGS. 1-4 illustrate in perspective a laser engraving machine carriage 10 of rectangular configuration comprising parallel spaced apart vertically oriented side frames 12 and 14 each of which is constructed using metal box beams of which the vertical beams shown at 16 are joined by horizontal top and bottom beams 18 and 20 respectively. Cross beams 22 also of box like construction join the frames 12 and 14 at the top, leaving the bottom of the carriage open for purposes which will become apparent. The connecting hardware used to join the various box beams of the frames 12 and 14 is illustrated in FIG. 8 and includes a number of metal brackets which are joined to the beams by machine screws in a well-known fashion. The beams may be made of any suitable material but are preferably made of aluminum or steel for dimensional stability and rigidity. Decorative panels 26 may be used to dress up the interior frames 12 and 14 as desired and may be made of a variety of materials including plastic and aluminum sheeting.

Each side frame 12 and 14 has fitted within the side beams thereof pair of vertical, spaced apart screw shafts 28 and 32 of which shaft 28 is connected to be rotated by a stepper motor 30 which is secured to the top beam 18 in each of the two frames.

The two threaded shafts on each side of the carriage 10 are coupled for synchronized rotation by means of belts 35 near the lower ends as shown in the Figures.

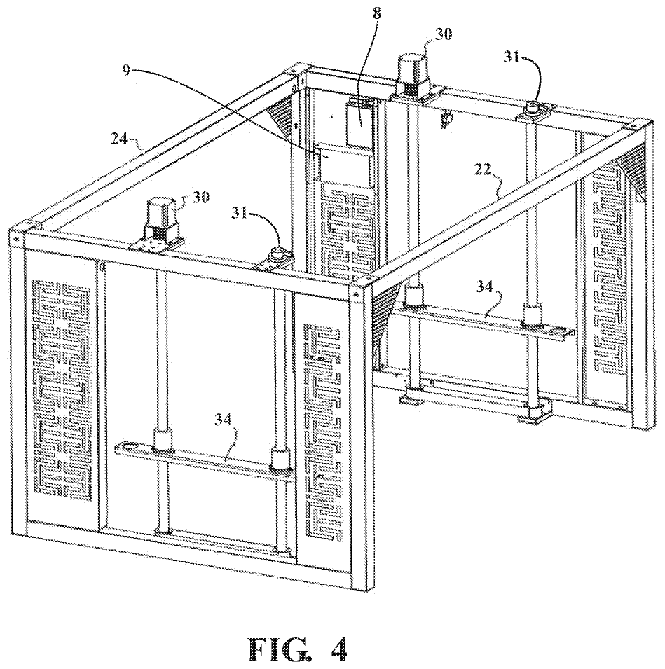

A horizontal support in the form of a rectangular pedestal 34 is connected between each set of screw shafts 28 and 32 by means of internally threaded couplings 36. Accordingly, activation of the stepper motors 30 rotates the shaft 28 and 32, the two shafts being coupled for simultaneous rotation by means of the belts 35. Since the pedestals 34 are carried by the shafts and are connected to the shaft by means of the internally threaded couplings 36, rotation of the shafts 28 and 32 by the stepper motors 30 causes the pedestals to synchronously raise and lower vertically by reason of the fact that the two stepper motors 30 are controlled by the same motor controller shown exposed in FIG. 4.

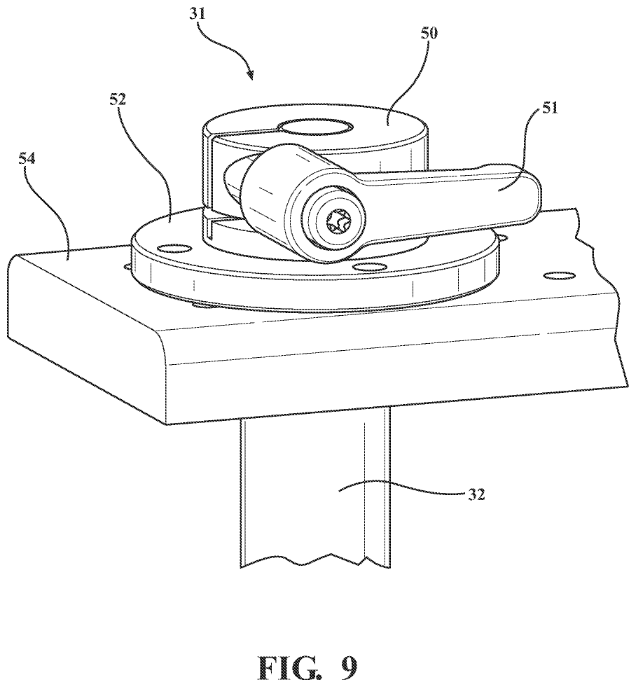

Locks 31 with manually operated levers 51 are attached to a screw shaft 32 on each side of the carriage 10 to selectively lock the shafts against inadvertent rotation from a desired elevation caused by the weight of a engraving machine 40 acting as a load on the pedestal 34 in the event of a motor failure. Such a motor failure could allow the screw shafts to free wheel and drop the engraving machine downwardly. As shown in FIG. 9, each lock consists of a slotted collar 50 surrounding a screw shaft extension and a lever 51 acts as a cam to squeeze the collars and lock the associated shafts into position when the lever is moved by hand into the locked position. Each lock 31 is mounted by way of a metal bezel 52 with bolt holes allowing it to be attached to a bracket 54 on the top beam of each of the two frames. When the elevation of the laser machine reaches the desired position, the levers on the locks are rotated from a unlocked position to a locking position thereby preventing inadvertent downward movement in the event of motor failure. When vertical adjustment is needed, the levers are rotated to unlock the screw shafts allowing the stepper motors to rotate the screw shafts as desired.

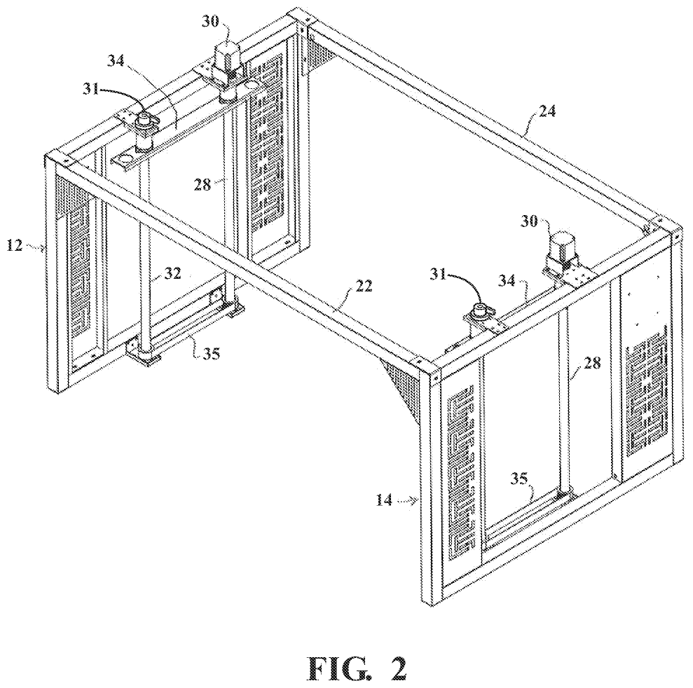

As mentioned above, FIG. 1 shows the pedestals 34 in a partially elevated position whereas FIG. 2 shows the pedestals 34 in the fully raised position. Again, the motors 30 are simultaneously activated so that the two pedestals 34 on opposite sides of the carriage are always in the same vertical position with one another. Separate mechanisms 42 can be used to change the angular orientation of the laser cabinet if needed; for example, if the object being engraved has a non-level surface.

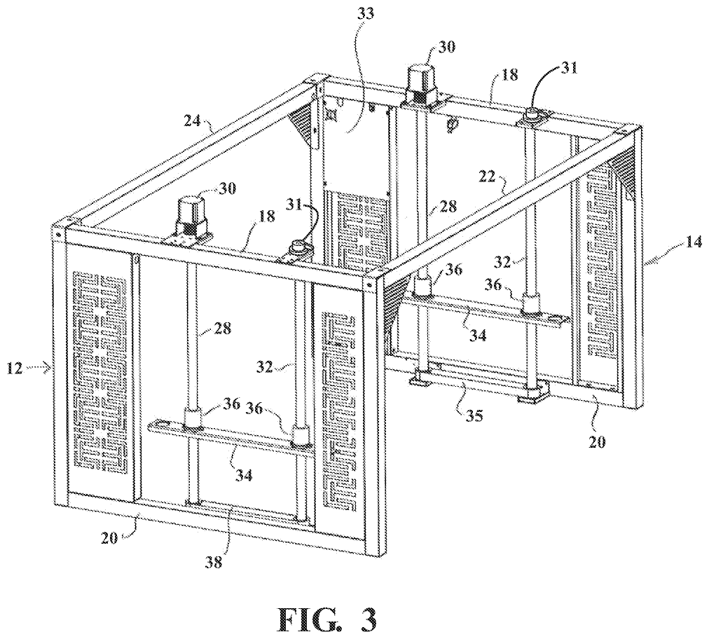

FIG. 3 shows a panel 33 covering a compartment at the top left-hand corner of the side panel 14 shown to the rear of FIG. 3 and FIG. 4 shows the same construction but with the stepper motor driver 8 exposed along with the power supply 9 which is used to drive the stepper motor.

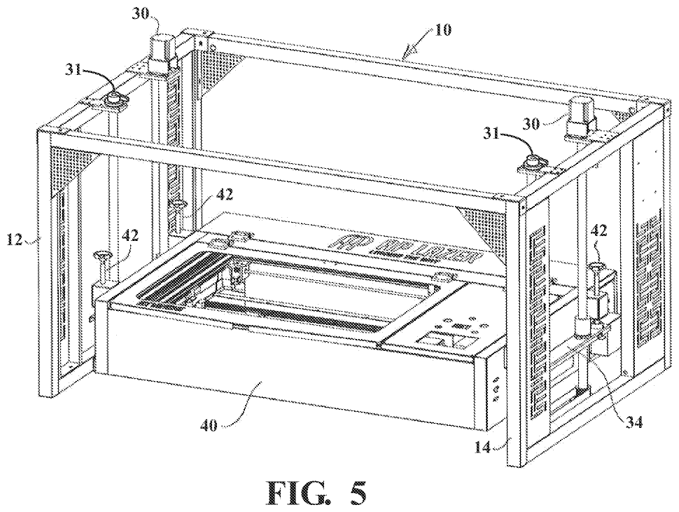

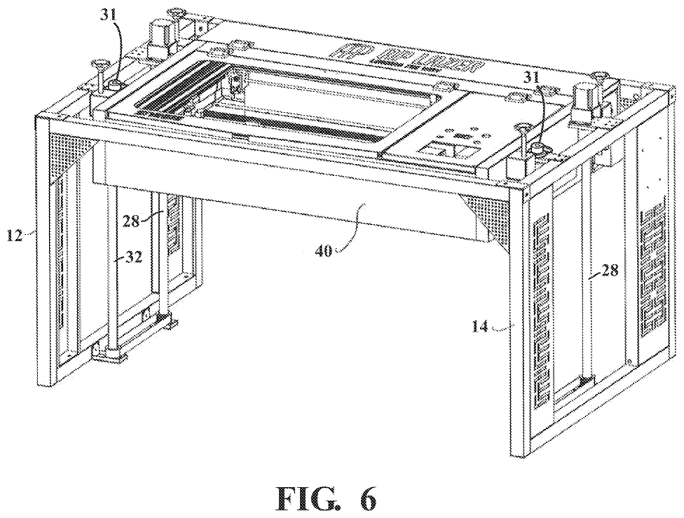

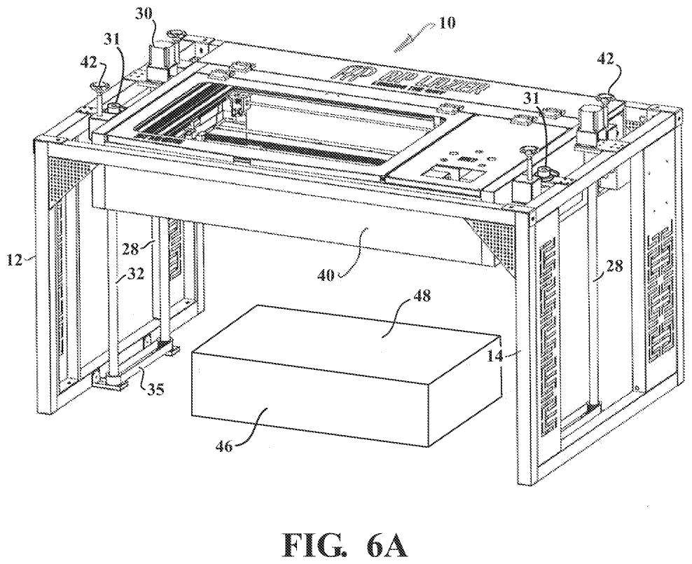

Referring now to FIG. 5, the carriage 10 is shown with a laser engraving machine 40 of the type described in my U.S. Pat. No. 10,654,127 issued in May of 2020. The laser engraving machine 40 is mounted to and between the pedestals 34 to be supported thereby. The machine 40 may simply rest on the pedestals or may be secured to them by means of hardware 42 which is fitted to the side panels of the laser housing so that the laser housing is raised and lowered along with the vertical motion of the pedestals 34 on the left and right sides of the carriage 10. The hardware 42 may include thumb wheel screw shafts which allow a degree of angular change in the orientation of the laser machine housing 40 in the event the workpiece to be engraved by the laser which is pointed through the bottom of the laser machine housing is not level. The figures, particularly FIGS. 5 and 6, however show the laser machine in a level position such that the X-Y field of laser displacement is horizontal.

FIG. 6A shows the laser cabinet 40 within the carriage 10 in the fully raised position and a workpiece 46, in this case a granite headstone, is placed within the space between the side frames 12 and 14 of the carriage and directly below the open bottom lasers such that the downwardly pointed or vertically pointed laser can etch a graphic or letters and numbers providing information in the top surface 48 of the workpiece. Of course, in normal operation the carriage would be activated to lower the pedestals and bring the laser engraving machine 40 down closer to the surface 48 of the headstone 46 and maintain the laser at the correct focal distance from the workpiece during the laser engraving operation.

As those skilled in the art will understand the laser engraving operation comprises a programed repeating horizontal scan to etch and remove material from the surface 48 of the workpiece according to a program that is entered in into the laser engraving machine digitally according to a pattern that produces number, letters and/or images.

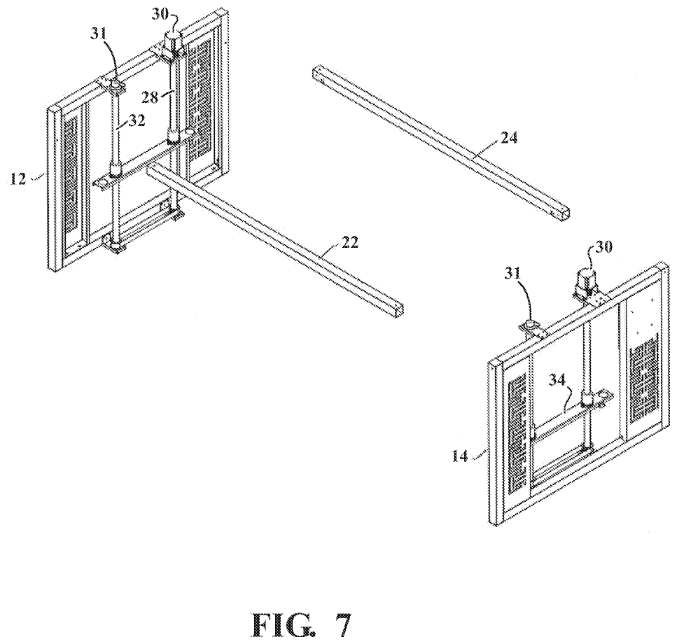

As indicated previously FIGS. 7 and 8 show the carriage components exploded; i.e. taken apart with the cross beam 22 and 24 not yet joined to the otherwise fully constructed side panels 12 and 14. On the other hand FIG. 8 shows the various components of hardware which are preferably made of metal and joined by machine screws to the metal box beams of the side panels to complete the construction of the carriage. The dimensions of the carriage both vertically, horizontally and depth wise can vary according to the size range of the laser engraving machines placed therein. Typically, dimensions might be 24″ in height, 50″ plus in horizontal width and approximately 36″ in depth but the dimensions are not to taken limiting as the carriage dimensions according to the specific use.

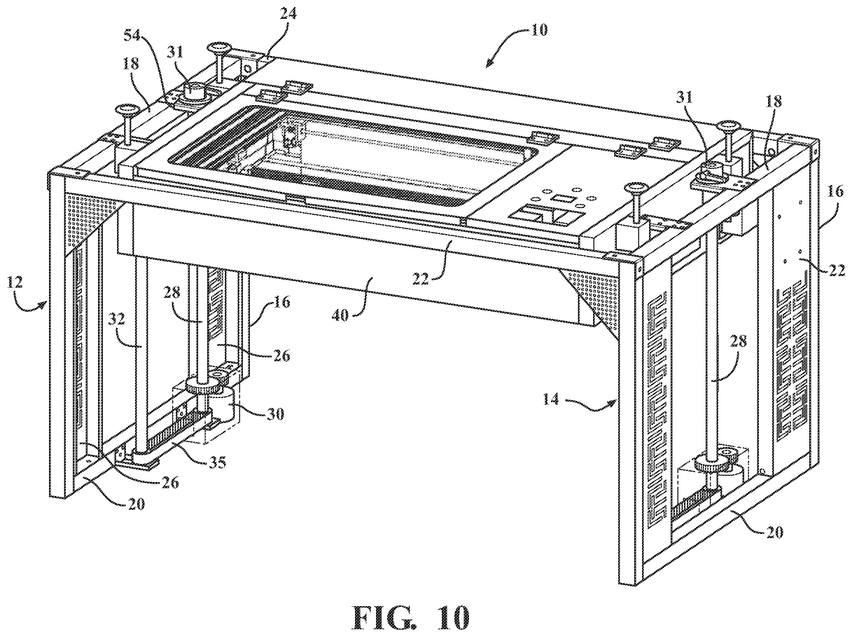

Referring to FIG. 10 the embodiment there shown includes a frame structure as essentially shown in FIGS. 1-8. However, the motors 30 are relocated to a position at or near the bottom of the shafts driven thereby through gear sets as shown. This removes the motor from the upper locations there by reducing the number of control elements at and around the top of the frame and further reducing the likelihood of inadvertent contact between an operator and the stepper motors as explained above.

What is claimed:

1. A carriage for a cabinet style laser engraving machine comprising:
first and second parallel horizontally spaced vertical frames;
a pedestal mounted to each of said first and second frames for receiving and supporting a laser engraver cabinet;
a motorized elevator system comprising vertically orientated stepper motor-driven screw shafts mounted to each of said vertical frames and to respective pedestals for raising and lower the pedestals in synchronism with one another;
said vertical frames and said pedestals being horizontally spaced apart to receive on said pedestals a laser engraver cabinet and determine the elevation of said cabinet relative to a workpiece location below the laser cabinet; and
means for selectively locking said screw shafts against rotation.

2. A carriage as defined in claim 1 wherein means are provided for mounting a laser cabinet to each pedestal and for allowing adjustment of the angular orientation of the laser cabinet.

3. A carriage as defined in claim 1 further including a stepper motor for controllably rotating a screw shaft in each of said vertically frames, each said stepper motor being located substantially at the bottom of a screw shaft and drivingly connected thereto

4. A carriage for receiving and supporting a laser engraver cabinet comprising:
a frame;
a pair of horizontally spaced apart pedestals mounted on said frame;
a set of vertically oriented screw shafts on said frame and connected to raise and lower respective pedestals;
a pair of motors for rotating respective screw shafts; said motors being mounted on said frame adjacent the bottoms of said screw shafts.
